(19) United States
(12) Patent Application Publication
(10) Pub. No.: US 2013/0138553 A1
(43) Pub. Date: May 30, 2013

(54) CREDIT SCORING BASED ON INFORMATION AGGREGATION

(71) Applicants: Andrey N. Nikankin, Sankt-Petersburg (RU); Rodion Shishkov, Sankt-Petersburg (RU)

(72) Inventors: Andrey N. Nikankin, Sankt-Petersburg (RU); Rodion Shishkov, Sankt-Petersburg (RU)

(73) Assignee: Rawllin International Inc.

(21) Appl. No.: 13/305,346

(22) Filed: Nov. 28, 2011

(51) Int. Cl. G06Q 40/02

(52) U.S. Cl. 705/38

(57) ABSTRACT

Disclosed are electronic systems and techniques for implementing credit scoring based on information aggregation. An aggregator component can obtain data relating to a user from virtually any open, publicly available, or private sources of information, and generate, or update, a profile of candidate characteristics based on the information obtained. A scoring calculation component can inspect the profile of candidate characteristics, determine a set of factors included in the profile of candidate characteristics that are relevant for a loan or credit eligibility determination, and rate the factors. A credit score for the user can be generated based on the ratings of the factors, and the eligibility of the user for one or more loans can be determined as a function of the credit score. In this regard, banks and retailers can automate credit scoring and loan eligibility determination using information about the applicant that is readily available.

### TECHNICAL FIELD

The subject application relates to electronic commerce, and, more particularly, to using aggregation of readily available information for credit scoring.

### BACKGROUND

A number of consumers have experience with short term loans, payday advances, cash advances, and so forth. These types of financial instruments often require proof of employment and financial viability, such as a checking account and evidence of employment. Typically, the interest rate for such instruments can be high, due to the level of risk experienced by the lender. However, when a consumer needs to obtain a quick credit decision, there may be few alternatives except borrowing from pawn shops, friends, or family.

Additionally, consumers are frequently presented with opportunities to apply for instant approval for credit cards during internet shopping, or at the point of sale during traditional in-store shopping. Often the consumer can charge a current purchase to the new account if they are approved, and may be able to take advantage of one or more promotions for applying. However, consumers having little, or no, credit history are unlikely to be approved for these credit cards. In addition, some consumers choose not to use credit cards, or elect not to go through the application process at the time of the offer is presented.

The above-described deficiencies of today's credit application are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for credit scoring based on information aggregation are contained herein. An exemplary system, includes a profile component configured to receive a profile of candidate characteristics associated with a user, a factor recognition component configured to determine a set of loan eligibility determination factors included in the profile of candidate characteristics, a rating component configured to rate at least one loan eligibility determination factor in the set of loan eligibility determination factors based at least in part on a set of approval criterion, and a scoring component configured to determine a credit score for the user based at least in part on the rating of the at least one loan eligibility determination factor.

In another non-limiting embodiment, an exemplary method is provided that includes receiving a profile associated with a user, determining a set of loan factors included in the profile, rating at least one loan factor in the set of loan factors based at least in part on a set of approval criterion, and determining a credit score as a function of the rating of the at least one loan factor.

In still another non-limiting embodiment, an exemplary computer readable storage medium is provided that includes receiving a profile associated with a user, determining a set of factors included in the profile, rating at least one factor included in the set of factors, and determining a credit score based at least in part on the rating of the at least one factor.

In yet another non-limiting embodiment, an exemplary system is provided that includes means for receiving a profile, means for determining a set of factors included in the profile, means for assigning a weight to at least one factor included in the set of factors, and means for determining a credit score based at least in part on the weight assigned to the at least one factor.

### BRIEF DESCRIPTION OF DRAWINGS

FIG. 1 illustrates an example system for credit scoring based on information aggregation in accordance with various aspects described herein;

FIG. 2 illustrates an example scoring calculation component in accordance with various aspects described herein;

FIG. 3 illustrates an example analysis component in accordance with various aspects described herein;

FIG. 4 illustrates an example scoring component in accordance with various aspects described herein;

FIG. 5 illustrates an example rating component in accordance with various aspects described herein;

FIG. 6 illustrates a block diagram of an exemplary non-limiting system that provides additional features or aspects in connection with credit scoring based on information aggregation;

FIG. 7 illustrates an example identifier input viewing pane in accordance with various aspects described herein;

FIG. 8 illustrates an example results viewing pane in accordance with various aspects described herein;

FIG. 9 illustrates an exemplary non-limiting implementation for credit scoring based on information aggregation;

FIG. 10 illustrates an exemplary non-limiting implementation for credit scoring based on information aggregation;

FIG. 11 is a block diagram representing exemplary non-limiting networked environments in which various non-limiting embodiments described herein can be implemented; and

FIG. 12 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

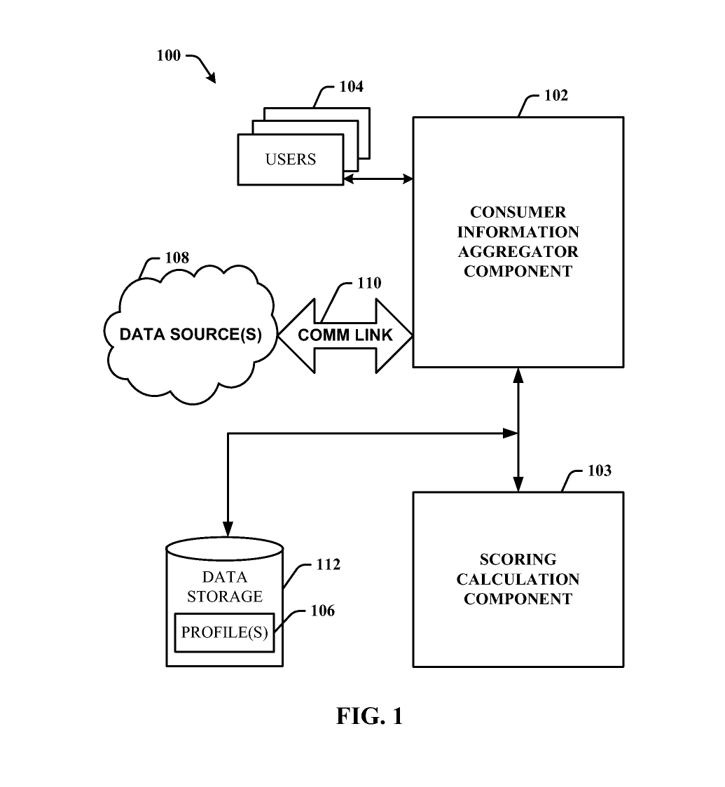

Referring initially to FIG. 1, illustrated is an example system 100 for credit scoring based on information aggregation in accordance with various aspects described herein. The system 100 includes a consumer information aggregator component 102 (aggregator component 102), and a scoring calculation component 103. The consumer information aggregator 102 can obtain, locate, or otherwise acquire data relating to a user 104, and generate a profile of candidate characteristics 106 (profile 106) based at least in part on the data. The aggregator component 102 obtains, acquires, or otherwise receives one or more identifiers associated with the user. For example, the identifiers can include but are not limited to the user's 104 name, date of birth, email address, home address, phone number, and so forth. The aggregator component The aggregator component 102 can acquire data relating to the user 104 by searching a set of data sources 108 using the identifiers, and collecting a set of search results. The data sources 108 can include virtually any open source or publicly available sources of information, including but not limited to websites, search engine results, social networking websites, online resume databases, job boards, government records, online groups, payment processing services, online subscriptions, and so forth. In addition, the data sources 108 can include private databases, such as credit reports, loan applications, and so forth. The aggregator component 102 can connect to the data sources 108 via a communication link 110 (e.g., comm link, network connection, etc). For example, the aggregator component 102 can obtain a set of data relating to the user 104 by querying one or more internet search engines based on the identifiers.

In addition, the aggregator component 102 can examine, inspect, or otherwise analyze information included in the set of search results, and generate the profile 106 for the user 104 based at least in part on the information. Generation of the profile 106 can include determining a subset of results in the search results, or a set of data included in the search results, that are relevant for inclusion in the profile 106 based on a correlation with a set of predetermined characteristics, or satisfaction of a set of predetermined criteria. For example, the set of predetermined criterion can include, but are not limited to, a relation of a search result to the user 104, a trustworthiness of the source from which the search result was obtained, or a classification of the result. As a more specific example, if the aggregator component 102 returns a social networking website profile for a user having the same name as the user 104, but the profile information (e.g., data birth, email address, etc.) is different from the identifiers known for the user 104, then the aggregator component 102 can determine that the social networking website profile, or information included in the social networking website profile, should not be included in the profile 106. Additionally or alternatively, the profile 106 can be generated by methods, systems, or devices, such as those disclosed in commonly owned, co-pending, U.S. patent application Ser. No. 13/299,877 (“the '877 application”), titled “CONSUMER INFORMATION AGGREGATOR AND PROFILE GENERATOR” herein incorporated by reference.

The scoring calculation component 103 can examine, inspect or otherwise analyze the profile 106, generate a credit score (e.g., grade, rank, risk assessment, etc.) for the user 104, and determine whether the user 104 is qualified, suitable, or otherwise eligible for one or more loans (e.g., lines or credit, advances, financing, etc.). The scoring calculation component 103 analyzes the profile 106 to determine whether various loan eligibility determination factors (factors) are included in the profile 106. For example, the factors can include, but are not limited to, the user's 104 employment, education, demographics, hobbies, residency, internet usage, and so forth. The credit score can be generated as a function of the factors included in the profile 106. For example, the scoring calculation component 103 can assess, grade, or weight one or more of the characteristics based on a set of scoring criterion, and determine the credit score based on the respective weights of the factors. The eligibility of the user 104 for one or more loans can be determined as a function of the credit score and a set of loan criterion. For example, the set of loan criterion can include a first credit score threshold for a first loan type, and a second credit score threshold for a second loan type, and the scoring calculation component 103 can determine whether the user's 104 credit score is within the first threshold or the second threshold. It is to be appreciated that although the profile 106 is illustrated as being stored in a data store 112, such implementation is not so limited. For instance, the profile 106 can associated with an online shopping portal, stored in a cloud based storage system, or the data storage 112 can be included in the aggregator component 102, scoring calculation component 103, or a data source 108. In addition, it is to be appreciated that although the aggregator component 102 and scoring calculation component 103 are illustrated as a stand-alone components, such implementation is not so limited. For instance, the aggregator component 102 or scoring calculation component 103 can be associated with or included in a software application, an online shopping portal, and so forth.

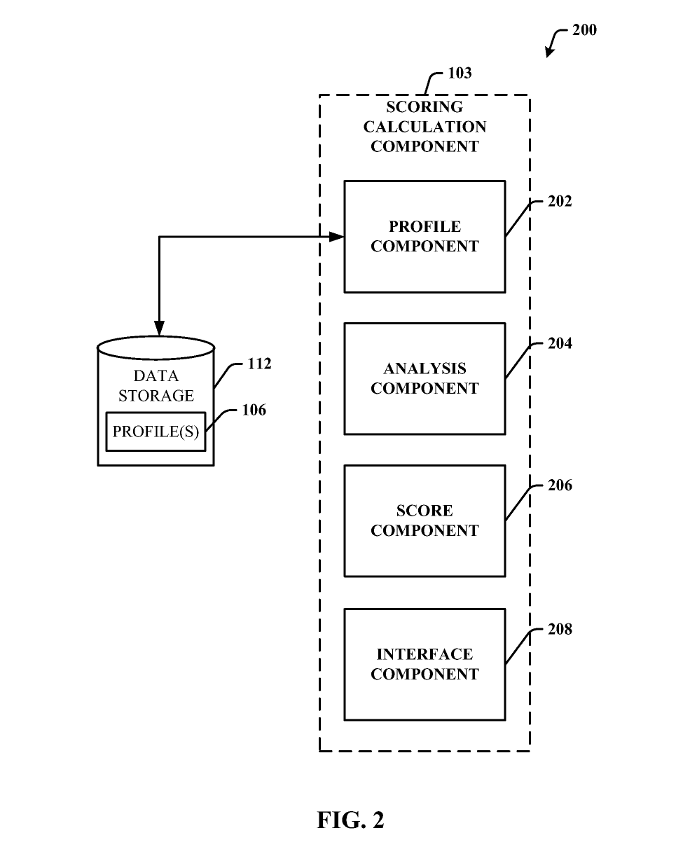

FIG. 2 illustrates an example scoring calculation component 103 in accordance with various aspects described herein. As discussed previously, the scoring calculation component 103 can analyze a user's 104 profile 106, generate a credit score for the user 104, and determine whether the user 104 is qualified for one or more loans (e.g., lines or credit, advances, financing, etc.) as a function of the profile 106. The scoring calculation component 103 can include a profile component 202, an analysis component 204, a scoring component 206, and an interface component 208. The profile component 202 can obtain, acquire, or otherwise receive a profile 106 associated with the user 104. The profile 106 can be saved, stored, or otherwise maintained in a data store associated with the scoring calculation component 103. Additionally or alternatively, the profile 106 can be maintained by a disparate entity. For example, the profile 106 can be associated with an online shopping portal, a website, an information aggregation service, or stored in a cloud based storage system.

The analysis component 204 can inspect, examine, or otherwise analyze the profile 106 to determine whether various factors are included in the profile 106. For example, the profile 106 can include a plurality of data fields associated with the user 104. The data fields can relate to virtually any information regarding the user, and a subset of the data fields (e.g., factors) may be relevant or pertinent for determining the user's 104 credit worthiness (e.g., making a loan eligibility determination). The analysis component 204 can analyze the profile 106, determine the presence of the subset of data fields that are relevant (e.g., factors) for the loan eligibility determination, and determine whether there are sufficient factors included in the profile 106 for the loan eligibility determination. A quantity of sufficient factors can be determined as a function of a set of predetermined analysis criterion. For instance, the predetermined analysis criterion can include a predetermined factors threshold, and if the profile 106 contains less factors than the factors threshold, then the loan eligibility determination for the user 104 may not be able to be completed. Furthermore, the analysis component 204 can classify, group, or otherwise categorize the factors for generating the user's credit score. For example, the features can be classified as a function of a data type associated with the candidate characteristic, or as a function of a loan type for which the eligibility of user 104 is being determined.

The scoring component 206 can compute, calculate, or otherwise determine a credit score (e.g., score) for the user 104 as a function of the factors included in profile 106 based on a set of predetermined scoring criterion. The scoring criterion can include weights or values for factors, data types associated with the factors, categories of the factors, and so forth. The scoring component 206 can determine the credit score for the user 104 as a function of the weights or values. In addition, the scoring component 206 can employ additional information in the credit score determination. For example, the additional information can include prior loan history, a promotional offer, and so forth. The scoring component 206 can further determine whether the user 104 is eligible for the one or more loans based at least in part on the credit score, and if the user is eligible for the loan determine a set of terms for the loan (e.g., max amount, interest rate, period, penalties, etc.).

The interface component 208 includes any suitable and/or necessary adapters, connectors, channels, communication paths, etc. to integrate the scoring calculation component 103 into virtually any operating and/or database system(s). Moreover, the interface component 208 can provide various adapters, connectors, channels, communication paths, etc., that provide for interaction with the scoring calculation component 103. It is to be appreciated that although the interface component 208 is illustrated as incorporated into the scoring calculation component 103, such implementation is not so limited. For instance, the interface component 208 can be a stand-alone component to receive or transmit data in relation to the scoring calculation component 103.

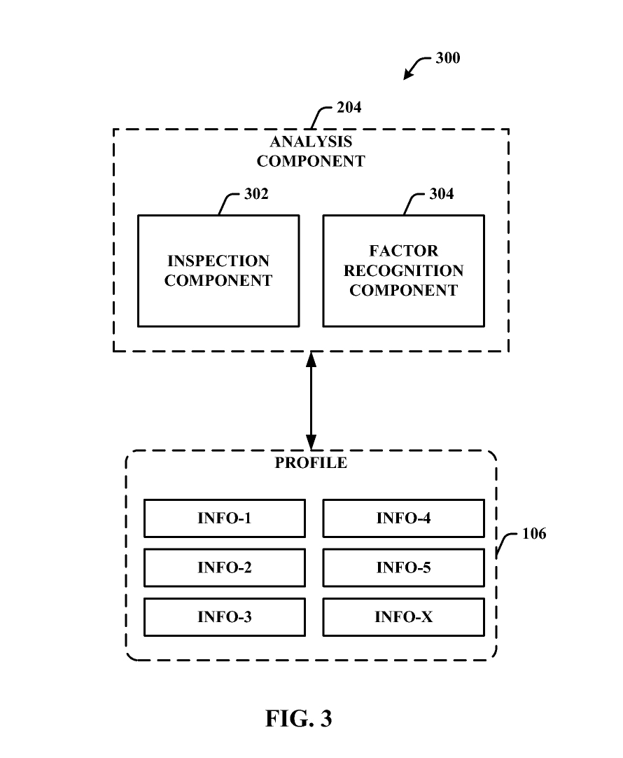

Turning now to FIG. 3, illustrated is an example analysis component 204 in accordance with various aspects described herein. As discussed previously, the analysis component 204 can analyze the profile 106 to determine whether various factors are included in the profile 106, and determine whether there are sufficient factors included in the profile 106 for the loan eligibility determination. The analysis component 204 can include an inspection component 302, and a factor recognition component 304.

The inspection component 302 can examine, investigate or otherwise inspect the profile 106. For example, the profile 106 can be maintained in multiple formats, languages, or structures and the inspection component 302 can enable parsing the profile 106 to obtain the factors. The factor recognition component 304 can identify, detect, or otherwise recognize factors relevant to the credit score determination within the profile 106. As discussed previously, the profile 106 can include a virtually infinite quantity of information (e.g., info-1 through info-x) relating to the user 104, wherein a subset of the information is relevant for the loan eligibility determination. The factor recognition component 304 can identify the subset of relevant information (e.g., loan factors or factors), for example, based on a comparison with a set of predetermined eligibility factors. For example, the set of predetermined eligibility factors can include the user's 104 work history, and the factor recognition component 304 can determine information (e.g., info-1) included in the profile 106 relating to the user's 104 work history. In addition, the factor recognition component 304 can compute, calculate, or otherwise determine additional factors based on the information included in the profile. For instance, the information included in the profile 106 can include a set of time frames corresponding to the length of employment of user 104 at disparate jobs. The factor recognition component 304 can determine an additional feature, how often the user 104 changes jobs (e.g., job change frequency), based on the set of time frames.

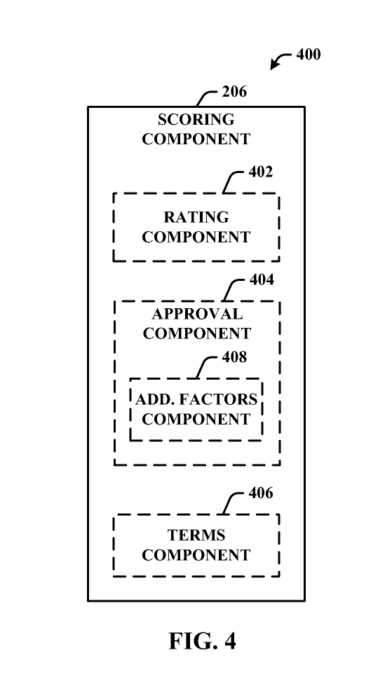

FIG. 4 illustrates an example scoring component 206 in accordance with various aspects described herein. As discussed previously, the scoring component 206 can determine a credit score (e.g., score) for the user 104 as a function of the factors included in, or determined from, the profile 106. The scoring component 206 can include a rating component 402, an approval component 404, and a terms component 406. The rating component 402 can grade, weight, or otherwise rate the factors included in, or determined from the profile 106, based on one or more sets of predetermined rating criteria. For example, a first type of loan can have a first set of predetermined rating criteria, and a second type of loan can have a second type rating criteria. For instance, if the first type of loan is a microloan (e.g., small value loan), then a region of residence factor may not be weighted. In contrast, if the type of loan is a large loan, then the region of residence factor may be heavily weighted. In addition, the rating component 402 can calculate, compute, or generate a credit score for the user 104 as a function of the factor ratings or weights. The rating component 402 can dynamically determine a credit score computation based on the factors included in the profile, and their respective ratings or weights. Additionally or alternatively, the rating component 402 can generate the credit score based on a predetermined set of credit score generation criterion.

The approval component 404 can determine whether the user eligible for one or more loans based at least in part on the credit score generated by the rating component 402 and a set of approval criterion. For example, the set of approval criterion can include a first approval threshold for a first type of loan, and if the credit score associated with the user 104 is within the first approval threshold, then the approval component 404 can determine that the user is eligible for the first type of loan. In addition, the approval component 404 can include an additional factors component 408. The additional factors component 408 can adjust, alter, or otherwise modify the set of approval criterion, or the user's 104 credit score, based on a set of additional factors. Continuing with the previous example, the additional factors can include a confidence score associated with the profile that indicates a likelihood of accuracy for the profile 106. If the confidence score is not within a predetermined confidence threshold, then the additional factors component 408 can adjust the first approval threshold to require a higher credit score for loan approval (e.g., make it more difficult to get the loan). The set of additional factors can include virtually any factor not included in the credit score determination, such as, financing promotions, authorized user overrides, loyalty rewards, and so forth. Additionally or alternatively, the approval component 404 can dynamically determine that the user 104 is eligible for a loan based on virtually any criterion (e.g., independent of the credit score). For example, the approval component 404 can approve the loan based on the user 104 being included in a pool of preapproved candidates, similar to targeted advertisements.

Where the user 104 is eligible for a loan, the terms component 406 can select, acquire, or otherwise determine a set of terms for the loan. The terms component 406 can select the set of terms from a set of predetermined terms, or the terms component 406 can dynamically generate the set of terms. The loan terms can include, but are not limited to, a financing amount (e.g., credit limit), an interest rate, a set of service fees, a set of penalties (e.g., late payment, over-the-limit, etc.), a period of the loan, and so forth. For example, the terms component 406 can determine a first set of terms if the user's 104 credit score indicates that they are high risk, a second set of terms if the user's 104 credit score indicates that they are average risk, and a third set of terms if the user's 104 credit score indicates they are low risk.

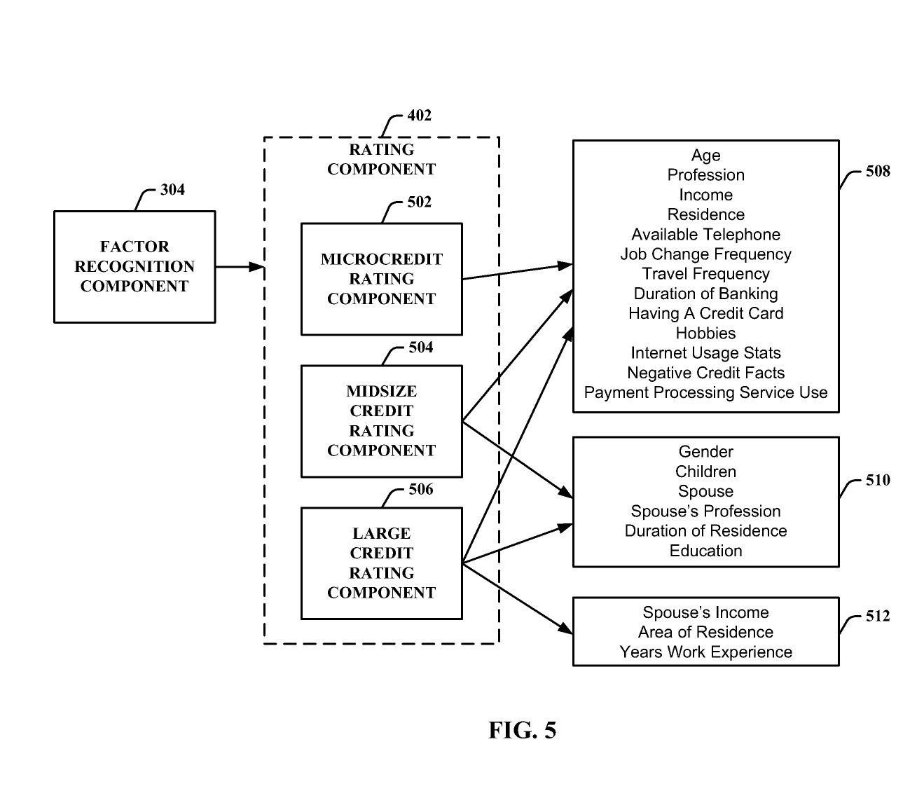

Turning now to FIG. 5, illustrated is an example rating component 402 in accordance with various aspects described herein. As discussed previously, the factor recognition component 304 can determine factors included in the profile 106, or determine factors based on information included in the profile 106. The rating component 402 can grade, weight, or otherwise rate the factors included in, or determined from, the profile 106 based on one or more sets of predetermined rating criteria. The sets of predetermined rating criteria can be associated with one or more loan types. For example, the rating component 402 can include a microcredit rating component 502, a midsize credit rating component 504, and a large credit rating component 506. The microcredit rating component 502 can include a set of rating criterion for microcredit loans, the midsize credit rating component 504 can include a set of rating criterion for midsize loans, and the large credit rating component 506 can include a set of rating criterion for large loans. The size of a loan can be determined based on a set of loan size criterion. For example, the set of loan size criterion can include a set of thresholds, such as, a microcredit threshold, a midsize credit threshold, and a large credit threshold.

The set of rating criterion for the microcredit rating component 502, the midsize credit rating component 504, and the large credit rating component 506 can be disparate, related, or can overlap. For example, the set of rating criterion for the microcredit rating component 502 can include rating criterion for a first set of factors 508, but not a second set of factors 510 or third set of factors 512. The set of rating criterion for the midsize credit rating component 504 can include rating criterion for the first set of factors 508 and the second set of factors 510, but not the third set of factors 512. In addition, the set of rating criterion for the large credit rating component 506 can include rating criterion for the first set of factors 508, the second set of factors 510, and the third set of factors 512. It is to be appreciated that although the rating component 402 is illustrated as including rating components for three types of loans (e.g., 502-506), such implementation is not so limited. For instance, the rating component 402 can include rating components having respective sets of loan criterion for a virtually infinite number of loan types.

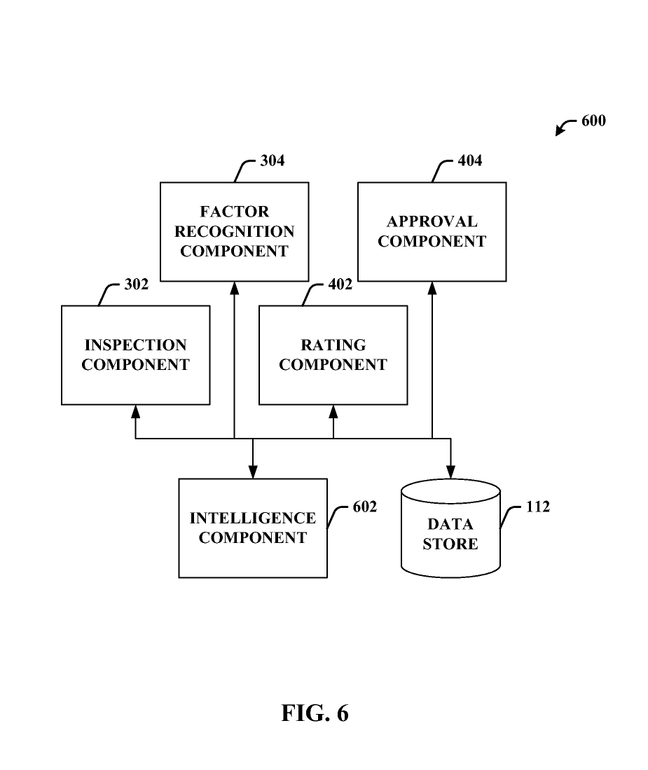

Referring now to FIG. 6, system 600 that can provide for or aid with various inferences or intelligent determinations is depicted. Generally, system 600 can include all or a portion of the inspection component 302, the factor recognition component 304, the rating component 402, and the approval component 404 as substantially described herein. In addition to what has been described, the above-mentioned components can make intelligent determinations or inferences. For example, inspection component 302 can intelligently determine or infer a format of the profile 106.

Likewise, the factor recognition component 304 can also employ intelligent determinations or inferences in connection with determining a set of factors included in the profile 106. In addition, the rating component 402 can intelligently determine or infer rating criterion, and generate a credit score. Additionally, the approval component 404 can intelligently determine or infer approval for one or more loans. Any of the foregoing inferences can potentially be based upon, e.g., Bayesian probabilities or confidence measures or based upon machine learning techniques related to historical analysis, feedback, and/or other determinations or inferences.

In addition, system 600 can also include an intelligence component 602 that can provide for or aid in various inferences or determinations. In particular, in accordance with or in addition to what has been described supra with respect to intelligent determination or inferences provided by various components described herein. For example, all or portions of the inspection component 302, the factor recognition component 304, the rating component 402, and the approval component 404 (as well as other components described herein) can be operatively coupled to intelligence component 602. Additionally or alternatively, all or portions of intelligence component 602 can be included in one or more components described herein. Moreover, intelligence component 602 will typically have access to all or portions of data sets described herein, such as in the data storage 112.

Accordingly, in order to provide for or aid in the numerous inferences described herein, intelligence component 602 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

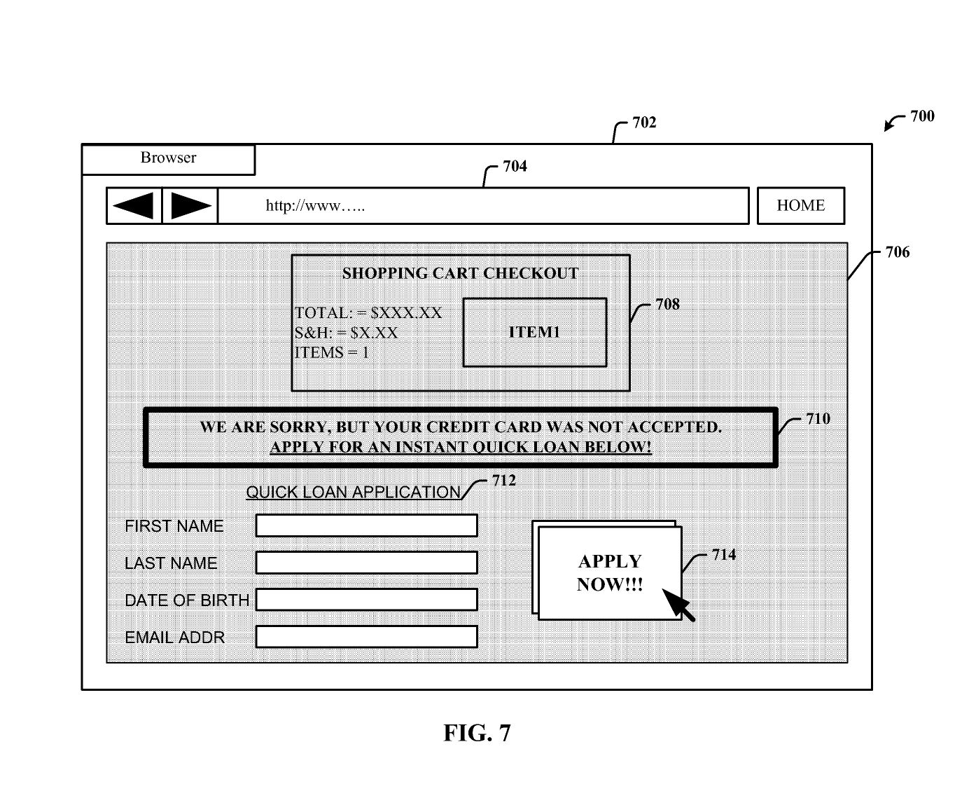

Turning to FIG. 7, illustrated is an example identifier input viewing pane 700 in accordance with various aspects described herein. As discussed previously, the aggregator component 700 can be associated with an internet shopping portal. The shopping portal can be accessed via a web browser 702 that includes an address bar 704 (e.g., URL bar, location bar, etc.). The web browser 702 can expose a checkout screen 706 that includes a shopping cart checkout section 708. The shopping cart checkout section 708 can include a set of items (e.g., item1) that a user (e.g., user 104) has selected, added to the shopping cart, or otherwise intends to purchase. The shopping cart checkout section 708 can include additional information related to the transaction, such as, a total purchase price, a number of items in the shopping cart, a shipping and handling charge for the items, and so forth.

The checkout screen 706 can further include an offer message 710. For example, the user may have attempted to purchase the items displayed in the shopping cart checkout section 708, but the transaction may have failed to complete for any of a plurality of reasons. For example, the user's credit card may have been declined, because they exceeded their maximum balance, or the user may have insufficient funds in an account associated with the credit card. The offer message section 710 can inform the user of the failed transaction, and can inform the user of an opportunity to apply virtually instantly for one or more loans (e.g., Instant Quick Loan).

An input section 712 (e.g., application) can contain a set of fields to be provided for the user to apply for the offer. The set of fields included in the input section 710 can be generated by the aggregator component 102 to acquire the set of identifiers (discussed previously). Additionally, the checkout screen 706 can include a completion button 712 (e.g., “apply now button”) that will initiate an offer eligibility determination. As discussed previously, the aggregator component 102 can determine and search a set of sources (e.g., data sources 108) for information relating to the user based on the set of identifiers, analyze the search results, and include the information in the profile 106.

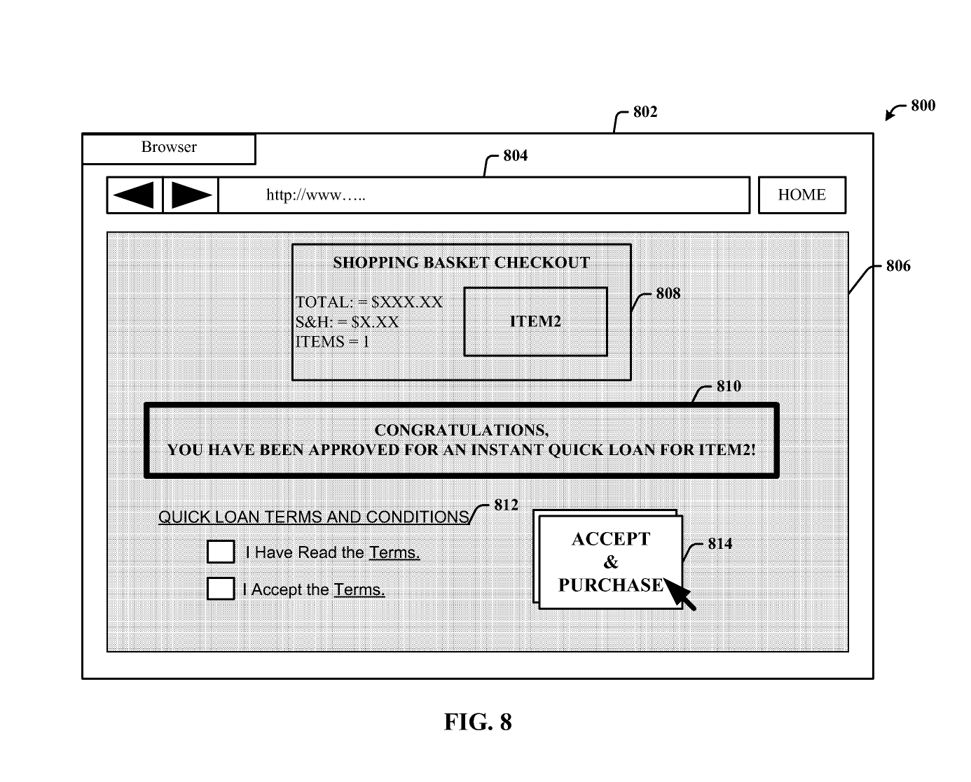

FIG. 8 illustrates an example results viewing pane 800 in accordance with various aspects described herein. The results viewing pane 800 can expose the results of a loan eligibility determination. The results viewing pane 800 can include a loan eligibility determination section 802. The loan eligibility determination section 810 can expose a result of the loan eligibility determination. For example, the loan eligibility determination section 810 can detail that the user is eligible for a loan for which they applied (See FIG. 7), or whether the user's application for the loan has been declined. Additionally, the loan eligibility determination section 810 can detail an additional loan for which the user is eligible. For instance, the user can apply for a first loan, and it can be determined (e.g., via the approval component 404) that the user is eligible for a second loan in addition to, or in place of, the first loan. As a further example, the user may have applied for a quick loan for item1, and it can be determined that the user is not eligible for the quick loan for the purchase price of item1, but is eligible for a quick loan for a purchase price of item2, where item2 is similar to, but costs less than, item1. As yet another example, it can be determined that the user is eligible for a quick loan for the purchase price of item1 and item2, where item1 and item2 are related items.

A terms and condition section 812 can enable the user to view the terms and conditions of any loans for which they are determined to be eligible. As discussed previously, the approval component 404 can determine a set of terms for the loan or loans. In addition, the terms and conditions section 806 can include one or more fields that require the user to acknowledge that they have read the terms and conditions, accept the terms and conditions, and so forth. A loan acceptance button 814 enables the user to accept the loans and the terms and conditions associated with the loans. For example, the user can complete the checkout process by selecting the loan acceptance button 814.

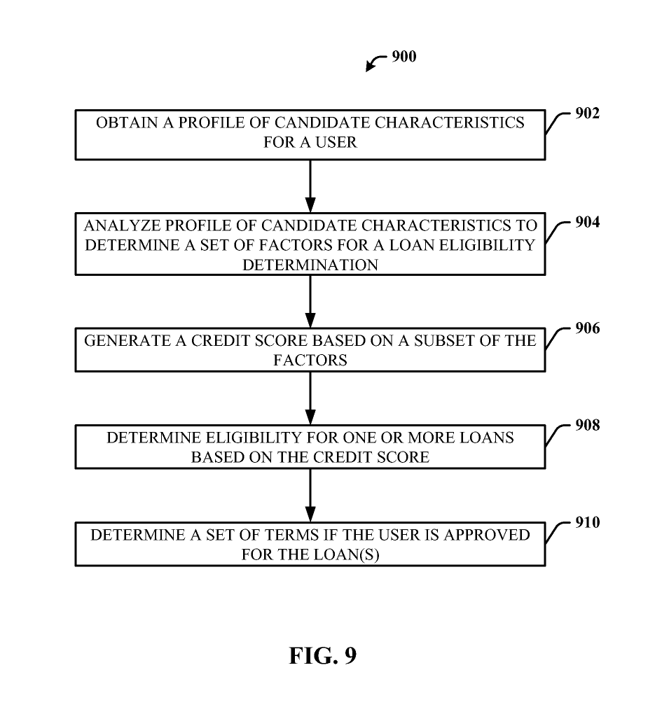

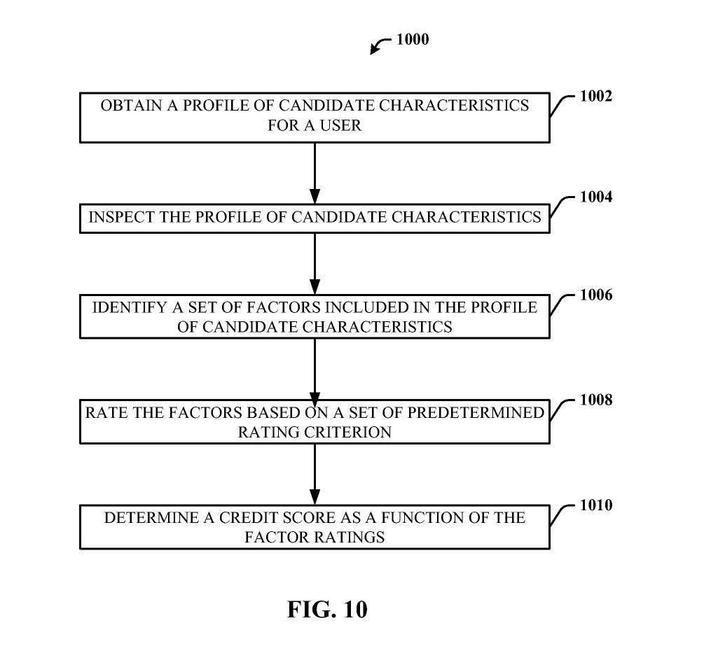

In view of the example systems described supra, methods that may be implemented in accordance with the described subject matter may be better appreciated with reference to the flow chart of FIGS. 9-10. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 9, illustrated is an example methodology for credit scoring with information aggregation 900 in accordance with various aspects described herein. Methodology 900 can begin at block 902, wherein a profile of candidate characteristics associated with a user is obtained. As discussed supra, the profile of candidate characteristics can be generated based on information relating to the user that has been gathered, searched, or otherwise obtained from a set of data sources. The data sources can include virtually any open source or publicly available sources of information, including but not limited to websites, search engine results, social networking websites, online resume databases, job boards, government records, online groups, payment processing services, online subscriptions, and so forth.

At 904, the profile of candidate characteristics (e.g., profile) is analyzed to determine a set of loan eligibility factors (e.g., loan factors, factors, etc.) included in the profile for use in a loan eligibility determination. The profile can include a plurality of data fields (e.g., information types, etc.) associated with the user, wherein the data fields can relate to virtually any information regarding the user. A set of the data fields that are relevant or pertinent for the loan eligibility determination (e.g., factors) can be selected.

At 906, a credit score for the user can be determined based in part on a subset of the factors and a set of predetermined scoring criterion. The scoring criterion can be based on a type of loan for which a loan eligibility determination is being made, and can include respective weights or values for factors included in the set of factors. For example, the subset of factors can include the user's area of residence (e.g., address) and the user's income. For a first loan type, the user's income can be weighted greater than the user's area of residence.

At 908, a determination is made whether the user is eligible for one or more loans based on the credit score. Returning to the previous example, a set of loan criterion for the first loan type can include an approval threshold. If the credit score determined for the user is within the approval threshold, then the user can be determined to be eligible for the first type of loan. In addition, a set of additional factors can be employed in determining whether the user is eligible for the one or more loans. The set of additional factors can include virtually any factor included or not included in the credit score determination, such as, an accuracy confidence score, financing promotions, authorized user overrides, loyalty rewards, and so forth. Additionally or alternatively, the determination of whether the user is eligible for the one or more loans can be dynamically made based on virtually any criterion (e.g., independent of the credit score). For example, it can be determined that the user is eligible based on the user being included in a pool of preapproved candidates, similar to targeted advertisements.

Where the user is eligible for a loan, a set of terms for the loan are determined, at 910. The set of terms can be selected from a set of predetermined terms, or dynamically generated. Continuing a prior example, a first set of terms (e.g., max amount, interest rate, period, etc.) can be determined if the credit score indicates the user is low risk, a second set of terms can be determined if the credit score indicates the user is average risk, and a third set of terms can be determined if the credit score indicates the user is high risk.

Referring to FIG. 10, illustrated is an example methodology for credit scoring with information aggregation 1000 in accordance with various aspects described herein. Methodology 1000 can begin at block 1002, wherein a profile of candidate characteristics associated with a user is obtained. As discussed supra, the profile of candidate characteristics can be generated based on information relating to the user that has been gathered, searched, or otherwise obtained from a set of data sources, including virtually any open or publicly available sources of information.

At 1004, the profile of candidate characteristics (e.g., profile) can be inspected. For example, the profile can be maintained in multiple formats, languages, or structures, and parsing of the profile in its format, language, or structure can be enabled in order to obtain information from the profile. At 1006, factors relevant to a loan or credit score determination included in the profile 106 can be identified. The profile can include a virtually infinite quantity of information relating to various data associated with the user, wherein a subset of the information is relevant for the loan eligibility determination (e.g., set of factor). The set of factors can be identified, for example, based on a comparison with a set of predetermined eligibility factors. Additionally or alternatively, factors can be determined based on the information included in the profile. For instance, the information included in the profile can include a set of time frames corresponding to the user's length of employment at disparate jobs, and a feature, such as how often the user changes jobs (e.g., a job change frequency feature), can be determined based on the set of time frames.

At 1008, the factors included in, or determined from the profile can be rated based at least in part on a set of predetermined rating criterion. For example, a first type of loan can have a first set of predetermined rating criteria, and a second type of loan can have a second type rating criteria. For instance, if the first type of loan is a microloan (e.g., small value loan), then a region of residence factor may not be weighted. In contrast, if the type of loan is a large loan, then the region of residence factor may be heavily weighted. At 1010, a credit score for the user can be determined as a function of the factor ratings. The credit score can be dynamically determined, or it can be determined based on a predetermined set of credit score generation criterion.

### Exemplary Networked and Distributed Environments

One of ordinary skill in the art can appreciate that the various non-limiting embodiments of the shared shopping systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

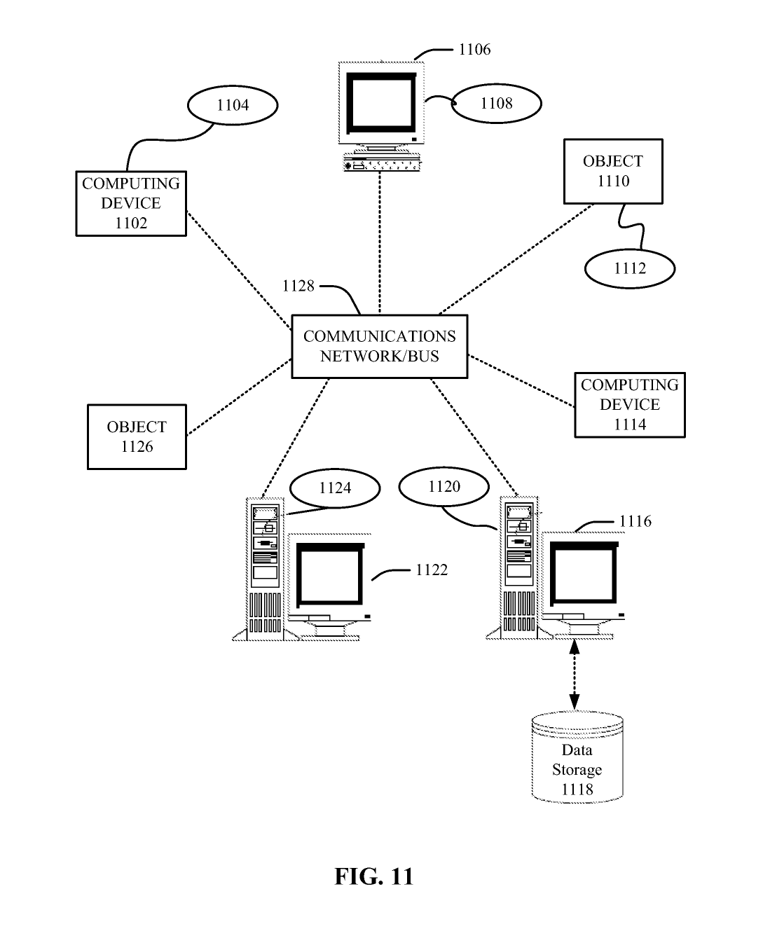

FIG. 11 provides a schematic diagram of an exemplary networked or distributed computing environment. The distributed computing environment comprises computing objects 1110, 1112, etc. and computing objects or devices 1120, 1122, 1124, 1126, 1128, etc., which may include programs, methods, data stores, programmable logic, etc., as represented by applications 1130, 1132, 1134, 1136, 1138. It can be appreciated that computing objects 1110, 1112, etc. and computing objects or devices 1120, 1122, 1124, 1126, 1128, etc. may comprise different devices, such as personal digital assistants (PDAs), audio/video devices, mobile phones, MP3 players, personal computers, laptops, etc.

Each computing object 1110, 1112, etc. and computing objects or devices 1120, 1122, 1124, 1126, 1128, etc. can communicate with one or more other computing objects 1110, 1112, etc. and computing objects or devices 1120, 1122, 1124, 1126, 1128, etc. by way of the communications network 1140, either directly or indirectly. Even though illustrated as a single element in FIG. 11, communications network 1140 may comprise other computing objects and computing devices that provide services to the system of FIG. 11, and/or may represent multiple interconnected networks, which are not shown. Each computing object 1110, 1112, etc. or computing object or device 1120, 1122, 1124, 1126, 1128, etc. can also contain an application, such as applications 1130, 1132, 1134, 1136, 1138, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 11, as a non-limiting example, computing objects or devices 1120, 1122, 1124, 1126, 1128, etc. can be thought of as clients and computing objects 1110, 1112, etc. can be thought of as servers where computing objects 1110, 1112, etc., acting as servers provide data services, such as receiving data from client computing objects or devices 1120, 1122, 1124, 1126, 1128, etc., storing of data, processing of data, transmitting data to client computing objects or devices 1120, 1122, 1124, 1126, 1128, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1140 or bus is the Internet, for example, the computing objects 1110, 1112, etc. can be Web servers with which other computing objects or devices 1120, 1122, 1124, 1126, 1128, etc. communicate via any of a number of known protocols, such as the hypertext transfer protocol (HTTP). Computing objects 1110, 1112, etc. acting as servers may also serve as clients, e.g., computing objects or devices 1120, 1122, 1124, 1126, 1128, etc., as may be characteristic of a distributed computing environment.

### Exemplary Computing Device

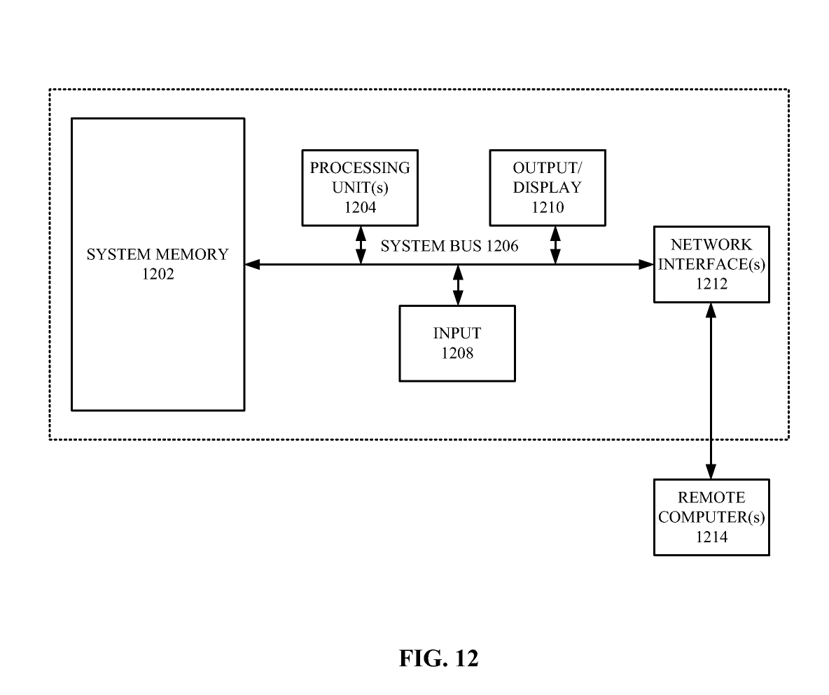

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 12 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 12 thus illustrates an example of a suitable computing system environment 1200 in which one or aspects of the non-limiting embodiments described herein can be implemented, although as made clear above, the computing system environment 1200 is only one example of a suitable computing environment and is not intended to suggest any limitation as to scope of use or functionality. Neither should the computing system environment 1200 be interpreted as having any dependency or requirement relating to any one or combination of components illustrated in the exemplary computing system environment 1200.

With reference to FIG. 12, an exemplary remote device for implementing one or more non-limiting embodiments includes a general purpose computing device in the form of a computer 1210. Components of computer 1210 may include, but are not limited to, a processing unit 1220, a system memory 1230, and a system bus 1222 that couples various system components including the system memory to the processing unit 1220.

Computer 1210 typically includes a variety of computer readable media and can be any available media that can be accessed by computer 1210. The system memory 1230 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 1230 may also include an operating system, application programs, other program modules, and program data.

A user can enter commands and information into the computer 1210 through input devices 1240. A monitor or other type of display device is also connected to the system bus 1222 via an interface, such as output interface 1250. In addition to a monitor, computers can also include other peripheral output devices such as speakers and a printer, which may be connected through output interface 1250.

The computer 1210 may operate in a networked or distributed environment using logical connections to one or more other remote computers, such as remote computer 1270. The remote computer 1270 may be a personal computer, a server, a router, a network PC, a peer device or other common network node, or any other remote media consumption or transmission device, and may include any or all of the elements described above relative to the computer 1210. The logical connections depicted in FIG. 12 include a network 1272, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” can include one criterion, or many criteria.

A number of embodiments have been described. Nevertheless, it will be understood that various modifications may be made without departing from the spirit and scope of the disclosure.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims and their equivalents.

1. A system, comprising:
a memory to store at least one computer-executable component; and
a processor, communicatively coupled to the memory, to execute or facilitate execution of the at least one computer-executable component, the at least one computer-executable component comprising:
a profile component configured to receive a profile of candidate characteristics associated with a user;
a factor recognition component configured to determine a set of nonfinancial loan eligibility factors associated with the user, wherein the set of nonfinancial loan eligibility factors are included in the profile of candidate characteristics;
a rating component configured to rate at least one nonfinancial loan eligibility factor in the set of nonfinancial loan eligibility factors based at least in part on a set of approval criteria; and
a scoring component configured to determine a credit score for the user based at least in part on the rating of the at least one nonfinancial loan eligibility factor.

2. The system of claim 1, further comprising an approval component configured to determine an eligibility of the user for one or more loans based at least in part on the credit score.

3. The system of claim 1, further comprising an information aggregation component configured to obtain a set of information relating to the user from a set of data sources.

4. The system of claim 3, wherein the information aggregation component is further configured to generate the profile of candidate characteristics associated with the user based at least in part on a subset of the set of information.

5. The system of claim 3, wherein the set of data sources includes at least one of a website, a search engine, a social networking site, an online resume database, a job board, a government record, an online group, a payment processing service, or an online subscription.

6. A method, comprising:
receiving a profile associated with a user;
determining a set of nonfinancial loan factors associated with the user, wherein the set of nonfinancial loan factors are included in the profile;
rating, using at least one processor, at least one nonfinancial loan factor in the set of nonfinancial loan factors based at least in part on a set of approval criterion; and
generating a credit score as a function of the rating of the at least one nonfinancial loan factor.

7. The method of claim 6, further comprising determining an eligibility of the user for at least one loan based at least in part on the credit score.

8. The method of claim 6, further comprising acquiring a set of information relating to the user from a set of data sources.

9. The method of claim 8, further comprising generating the profile for the user based at least in part on a subset of the set information.

10. The method of claim 8, wherein the acquiring the set of information relating to the user from the set of data sources, includes acquiring the set of information from at least one of a website, a search engine, a social networking site, an online resume database, a job board, a government record, an online group, a payment processing service, or an online subscription.

11. A computer readable storage medium comprising computer executable instructions that, in response to execution, cause a computing system to perform operations, comprising:
receiving a profile associated with a user;
determining a set of data fields associated with the user, wherein the set of data fields are included in the profile and are not associated with a financial asset of the user;
rating at least one data field included in the set of data fields; and
determining a credit score based at least in part on the rating of the at least one data field.

12. The computer readable storage medium of claim 11, further comprising determining an eligibility of the user for one or more loans based at least in part on the credit score.

13. The computer readable storage medium of claim 11, further comprising acquiring a set of information relating to the user from a set of data sources.

14. The computer readable storage medium of claim 13, further comprising generating the profile for the user based at least in part on a subset of the set of information.

15. The computer readable storage medium of claim 13, wherein the acquiring the set of information relating to the user from the set of data sources, includes acquiring the set of information from at least one of a website, a search engine, a social networking site, an online resume database, a job board, a government record, an online group, a payment processing service, or an online subscription.

16. A system, comprising:
means for receiving a profile;
means for determining a set of factors included in the profile, wherein the set of factors are not related to a monetary asset;
means for assigning a weight to at least one factor included in the set of factors; and
means for determining a credit score based at least in part on the weight assigned to the at least one factor.

17. The system of claim 16, further comprising means for determining an eligibility of a user associated with the profile for one or more loans based at least in part on the credit score.

18. The system of claim 16, further comprising means for gathering a set of information relating to a user from a set of data sources.

19. The system of claim 18, further comprising means for generating the profile based at least in part on a subset of the set of information.

20. The system of claim 18, wherein the means for obtaining the set of information relating to the user from the set of data sources, includes means for obtaining the set of information from at least one of a website, a search engine, a social networking site, an online resume database, a job board, a government record, an online group, a payment processing service, or an online subscription.
